(19) United States
(12) Patent Application Publication
(10) Pub. No.: US 2016/0217181 A1
(43) Pub. Date: Jul. 28, 2016

(54) Annotating Query Suggestions With Descriptions

(71) Applicant: Google Inc., (US)

(72) Inventors: David Kadouch, Zichron Yaacov (IL); Sivan Eiger, Netanya (IL); Lev Finkelstein, Haifa (IL); Alon Mittelman, Tel-Aviv (IL); Dan Guez, Haifa (IL); Uri Bernstein, Tel-Aviv (IL); Valeria Helfand, Haifa (IL); Yosi Markovich, Haifa (IL); Eddo Kim, Raanana (IL)

(73) Assignee: Google Inc., Mountain View, CA (US)

(21) Appl. No.: 13/830,011

(22) Filed: Mar. 14, 2013

Related U.S. Application Data
(60) Provisional application No. 61/678,074, filed on Jul. 31, 2012.

(51) Int. Cl. G06F 17/30

(52) U.S. Cl. CPC G06F 17/30448

(57) ABSTRACT

Methods and apparatus for annotating query suggestions. Some implementations are directed to methods and apparatus for annotating a query suggestion with a semantic description to provide additional information about the meaning of the query suggestion.

### CROSS REFERENCE TO RELATED APPLICATIONS

This application claims the benefit of U.S. Provisional Application Ser. No. 61/678,074 filed on Jul. 31, 2012, entitled “Annotating Query Suggestions with Descriptions,” the disclosure of which is incorporated by reference herein in its entirety.

### BACKGROUND

This specification is directed generally to query suggestions for a query. Information retrieval systems, such as Internet search engines, enable users to locate information in a large database. For example, Internet search engines enable users to access information such as web pages, images, text documents, and/or multimedia content in response to a search query submitted by a user consisting of one or more search terms.

Some information retrieval systems may provide one or more query suggestions to a user as the user is typing a query and/or after a user has submitted a query. The user may choose one of the query suggestions to utilize as a submitted query and/or to utilize as the basis for a submitted query (e.g., by modifying, adding to, and/or subtracting from the selected query suggestion). The query suggestions are often generated via past user queries and/or generated automatically.

### SUMMARY

The present disclosure is directed to methods and apparatus for annotating query suggestions. For example, some implementations are directed to methods and apparatus for annotating a query suggestion with a semantic description to provide additional information about the meaning of the query suggestion.

In some implementations a computer implemented method for annotating query suggestions is described that includes the steps of: identifying query suggestions for a query; determining that a selected query suggestion of the query suggestions is ambiguous; identifying the selected query suggestion for annotating with a description, the identifying based on determining that the selected query suggestion is ambiguous; identifying a description for the selected query suggestion; and appending the description to the query suggestion for providing to a user as an annotated query suggestion in response to entry of the query by the user.

This method and other implementations of technology disclosed herein may each optionally include one or more of the following features.

The method may further include identifying an initial set of a plurality of potential descriptions for the selected query suggestion and selecting the description from the initial set of the potential descriptions. The method may further include identifying a document centric weighting component of each of the potential descriptions in at least one resource and the description may be selected based at least in part on the document centric weighting component thereof.

The step of identifying the selected query suggestion may include determining whether the selected query suggestion references an entity. The description may be selected based on association with the entity in at least one resource. Determining whether the selected query suggestion references an entity may be based on comparing one or more terms of the selected query suggestion to at least one property of a known entity.

The method may further include identifying at least one additional description for the selected query suggestion. The method may further include the step of appending the additional description to the query suggestion for providing to a user as an additional annotated query suggestion in response to entry of the query by the user. The step of determining whether the selected query is ambiguous may include: issuing a search based on the selected query suggestion; identifying search results based on the search; identifying ambiguity of the search results, wherein ambiguity of the search results is based on entities identified in the search results; and determining the selected query suggestion is ambiguous based on the ambiguity of the search results.

The step of identifying the selected query suggestion of the query suggestions may include analyzing a group of provided search results based on the query suggestion.

In some implementations a computer implemented method for selecting a description for a query suggestion is described that includes the steps of: identifying a query suggestion; identifying an initial group of descriptions related to the query suggestion; weighting each description of the initial group of descriptions based on document centric weight in at least one resource document; and selecting a display description from the initial group of descriptions based at least in part on the weight of the display description, the display description selected for appending as an annotation to the query suggestion.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

Particular implementations of the subject matter described herein analyze one or more aspects of query suggestions to create accompanying query suggestion annotations related to the query suggestions for potential utilization in one or more information retrieval systems. These one or more query suggestion annotations represent new query suggestion annotations that are derived from one or more identified query suggestions that may be based on a submitted partial query. The query suggestion annotations may be utilized by one or more information retrieval systems to provide improved query suggestions to users of the information retrieval systems.

It should be appreciated that all combinations of the foregoing concepts and additional concepts discussed in greater detail herein are contemplated as being part of the inventive subject matter disclosed herein. For example, all combinations of claimed subject matter appearing at the end of this disclosure are contemplated as being part of the inventive subject matter disclosed herein.

### BRIEF DESCRIPTION OF THE DRAWINGS

FIG. 1 is a block diagram of an example environment in which an implementation of a method of annotating query suggestions for a query may be implemented.

FIG. 2 is a flow chart illustrating an example method of annotating query suggestions for a search query.

FIG. 3 is a flow chart illustrating an example method of selecting a description to display in combination with a query suggestion.

FIG. 4 illustrates a partial screenshot of an example environment that can be used to provide query suggestion results to a user.

FIG. 5 illustrates another partial screenshot of an example environment that can be used to provide query suggestion results to a user.

FIG. 6 illustrates a block diagram of an example computer system.

### DETAILED DESCRIPTION

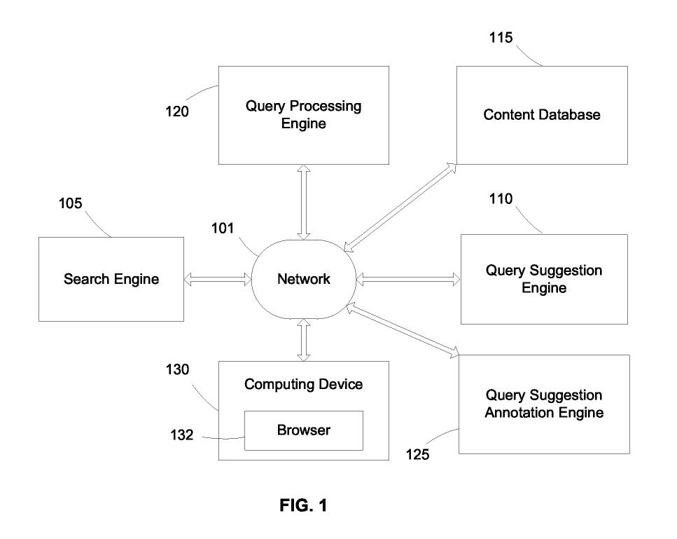

Referring to FIG. 1, a block diagram is illustrated of an example environment in which implementations of a method of annotating query suggestions for a search query may be implemented. The environment includes computing device 130, search engine 105, query processing engine 120, content database 115, query suggestion engine 110, and query suggestion annotation engine 125. The environment also includes a communication network 101 that enables communication between various components of the environment.

The query processing engine 120 may process query suggestions according to aspects of one or more implementations of methods described herein to facilitate determination of whether it is desirable to annotate one or more of those query suggestions. In some implementations such a determination may be made via analysis of search results for one or more of the returned query suggestions, analysis of one or more databases, analysis of one or more terms in the partial search query or submitted search query that generated the query suggestions, and/or analysis of one or more of the query suggestions. The query processing engine 120 may perform one or more steps of methods described herein and may optionally communicate with the query suggestion engine 110, the query suggestion annotation engine 125, and/or the search engine 105. For example, the query processing engine 120 may receive a plurality of query suggestions from the query suggestion engine 110, utilize search results provided by the search engine 105 in determining whether to annotate one or more of the query suggestions, and provide identification of the query suggestions to annotate to query suggestion annotation engine 125. The query processing engine 120 may be implemented in hardware, firmware, and/or software running on hardware. For example, the query processing engine 120 may be implemented in one or more computer servers and/or one or more client computing devices. The query processing engine 120 may optionally contain one or more modules such as, for example, an entity identification module and/or an ambiguous query suggestion identification module. The query processing engine 120 is described in more detail with reference to additional Figures herein.

In some implementations the query that is processed by the query suggestion engine 110 to provide query suggestions may be a partial query entered by a user for submission to an information retrieval system such as search engine 105. In some implementations a user may interact with the search engine 105 through a client computing device 130. The client computing device 130 and the search engine 105 each include memory for storage of data and software applications, a processor for accessing data and executing applications, and components that facilitate communication over a communication network 101. The computing device 130 executes one or more applications, such as web browsers (e.g., web browser 132), that enable the user to formulate completed queries and submit completed queries to the search engine 105. In some implementations completed queries may be submitted directly to the search engine 105 from the computing device 130. In some implementations completed queries may be submitted from the query suggestion engine 110, query processing engine 120, and/or the query suggestion annotation engine 125 to the search engine 105.

The search engine 105 receives a completed query and executes the completed query against a search engine content database of available documents such as web pages, images, text documents, and/or multimedia. In some implementations the search engine content database may be implemented in content database 115. The search engine 105 identifies content which matches the submitted query and responds by generating search results that are transmitted to one or more devices in a form that is useful for the devices. For example, search results may be transmitted to the computing device 130 in a form that can be presented to the user. For example, in response to a query from the computing device 130, the search engine 105 may transmit a plurality of search results to be displayed in the web browser 132 that is executing on the computing device 130.

The search engine 105 may optionally access log files of past queries submitted to the search engine 105 by prior users during prior query sessions. The log files may be stored on one or more computers and/or storage devices such as, for example, content database 115. The content database 115 may include one or more storage mediums. For example, in some implementations the content database 115 may include one or more storage mediums on multiple computer servers. Any maintained log files may be anonymous and not traceable to a particular user.

The one or more applications executing on the computing device 130 also provide partial queries being formulated by users, before the users have indicated completion of the queries. The applications may be, for example, a web browser, a toolbar running in a web browser, and/or a search client running on the computing device 130. In some implementations the applications provide each character of a query as it is typed or otherwise entered by the user. In some implementations the applications provide multiple characters at a time, optionally following a pause by the user between character entries.

A partial query is a query formulated by a user prior to an indication by the user that the query is a completed query. In some implementations a user may indicate a completed query by entering a carriage return and/or other character. In some implementations a user may indicate a completed query by selecting a search button in a user interface presented to the user. In some implementations a user may indicate a completed query by speaking a command in a speech user interface. In some implementations a user may indicate a completed query by pausing more than a predetermined amount of time during entering of the query. Additional and/or alternative forms of providing a partial query and/or indicating a completed query may optionally be utilized.

In some implementations, in response to a partial query, the search engine 105 receives the partial query and forwards the partial query to the query suggestion engine 110. In some implementations, in response to a partial query, the one or more applications executing on the computing device 130 may optionally directly forward the partial query to the query suggestion engine 110. For example, in some implementations the browser 132 may directly forward the partial query to the query suggestion engine 110. The query suggestion engine 110 includes memory for storage of data and software applications, a processor for accessing data and executing applications, and components that facilitate communication over the communication network 101. The query suggestion engine 110 may then match the submitted partial query to one or more of a plurality of query suggestions that are an appropriate match to the partial query. In some implementations the query suggestions may represent potential completed queries and be provided to a user to enable the user to choose one of the query suggestions as a basis for utilization in a search or other information retrieval application.

In some implementations the query suggestions may be determined based on a list of past user queries, a list of automatically generated queries, and/or real time automatically generated queries. For example, the query suggestion engine 110 may use prefix based matching to identify query suggestions from a list of past user queries. The query suggestion engine 110 then provides these query suggestions to a user. In some implementations the query suggestion engine 110 may provide the query suggestions to a user via the search engine 105, the query processing engine 120, the query suggestion annotation engine 125, and/or to the computing device 130 directly. Any listing of past user queries and/or past automatically generated queries may optionally be stored in a query suggestion content database such as content database 115, for potential utilization as query suggestions.

These query suggestions provided by the query suggestion engine 110 represent queries that a user may want to submit in addition to or instead of the partial queries actually being typed. The query suggestions may, for example, be displayed within a cascaded drop down menu of the search field of an application, such as a web browser executing on the computing device 130, as the user is typing the query. In some implementations one or more search results responsive to a partial query and/or responsive to a query suggestion for the partial query may also optionally be displayed as the user is typing the query.

The query suggestion annotation engine 125 may identify descriptions related to one or more of the query suggestions according to aspects of one or more implementations of methods described herein to facilitate a user's determination of the meaning of such query suggestions. In some implementations query suggestion annotation engine 125 may communicate with query processing engine 120 in determining when to generate and/or identify descriptions related to query suggestions and/or for which query suggestions descriptions are desired. In some implementations query suggestion annotation engine 125 may communicate with search engine 105, content database 115, and/or other application or repository to identify descriptions related to query suggestions. For example, in some implementations a description for a query suggestion may be identified at least in part by selecting the description from a database (e.g., content database 115) having a plurality of descriptors for a given query suggestion. Also, for example, in some implementations a description for a query suggestion may be identified at least in part by analysis of search results (e.g., from search engine 105) pertaining to the query suggestion.

The query suggestion annotation engine 125 may perform one or more of the steps of methods described herein. The query suggestion annotation engine 125 may be implemented in hardware, firmware, and/or software running on hardware. For example, the query suggestion annotation engine 125 may be implemented in one or more computer servers and/or one or more client computing devices.

In some implementations the search engine 105 and/or the computing device 130 may optionally additionally or alternatively provide a completed query to the query suggestion engine 110. A completed query is a query that the user has indicated is complete. The query suggestion engine 110 may then match the completed query to one or more query suggestions to determine one or more query suggestions for the user's completed query. The query suggestion engine 110 then provides these query suggestions to the user. In some implementations the query suggestion engine 110 may provide the query suggestions to a user via the search engine 105, the query processing engine 120, the query suggestion annotation engine 125, and/or the computing device 130 directly. The query suggestions may, for example, be embedded within a search results web page to be displayed in an application, such as the web browser 132, as potential further search options and may optionally include query suggestion annotations for one or more of the query suggestions.

The communication network 101 facilitates communication between the various components in the environment. In some implementations the communication network 101 may include the Internet, one or more intranets, and/or one or more bus subsystems. The communication network 101 may optionally utilize one or more standard communications technologies, protocols, and/or inter-process communication techniques.

Many other configurations are possible having more or less components than the environment shown in FIG. 1. For example, although the query processing engine 120 and the query suggestion annotation engine 125 are each illustrated alone in FIG. 1, it is understood that the query processing engine 120 and/or the query suggestion annotation engine 125 may optionally be combined with one another and/or with one or more of the query suggestion engine 110, the search engine 105, and/or the computing device 130 in some implementations. For example, the query processing engine 120 and/or the query suggestion annotation engine 125 may optionally be combined as part of the web browser 132 and/or as a separate application of the computing device 130. Also, for example, two or more of the query processing engine 120, the query suggestion annotation engine 125, and the query suggestion engine 110 may be combined in some implementations.

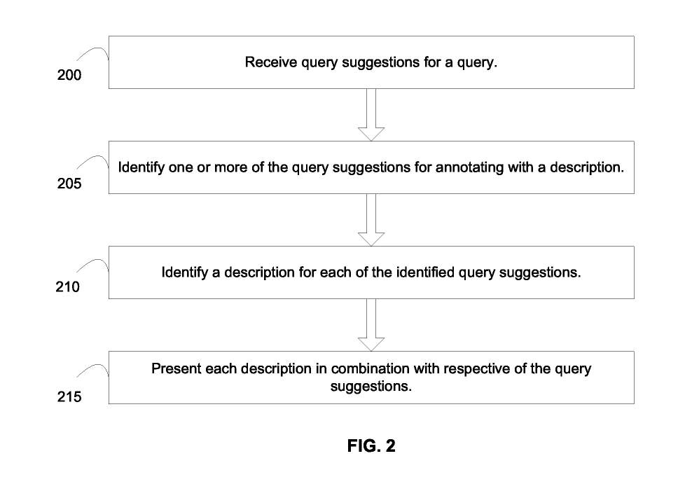

Referring to FIG. 2, a flow chart illustrating steps of an example method of annotating query suggestions for a search query is illustrated. Other implementations may perform the steps in a different order, omit certain steps, and/or perform different and/or additional steps than those illustrated in FIG. 2. For convenience, aspects of FIG. 2 will be described with reference to a system of one or more computers that perform the process. The system may include, for example, the query processing engine 120 and/or the query suggestion annotation engine 125 of FIG. 1.

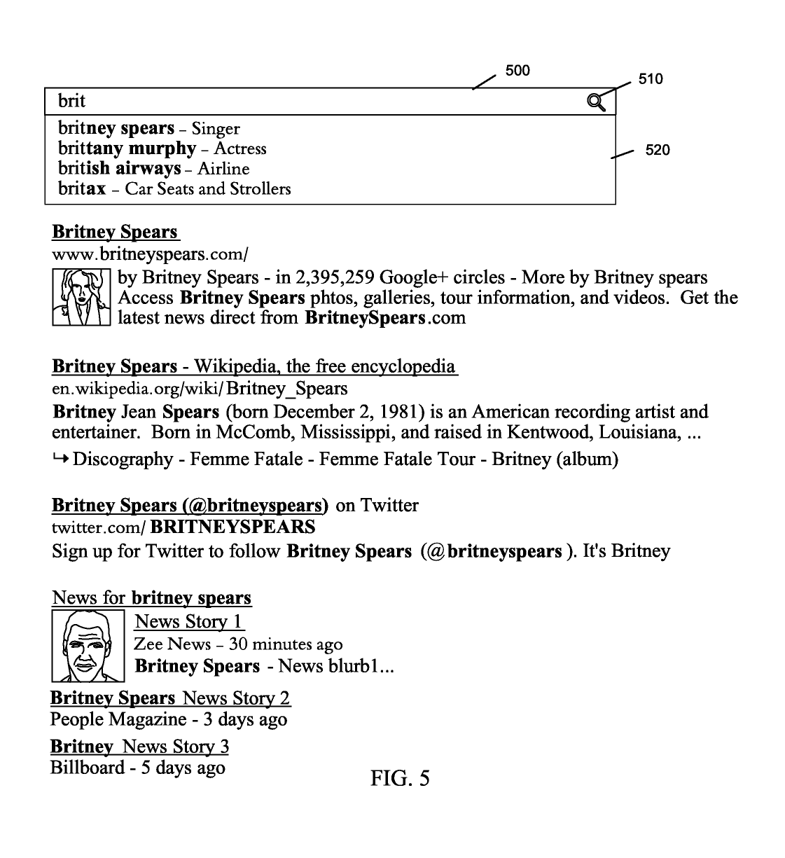

At step 200 query suggestions are identified. For example, as illustrated in FIG. 5, in a partial query of “brit”, “britney spears”, “brittany murphy”, “british airways”, and “britax” may be identified as query suggestions. In some implementations the query suggestions may be transmitted to the query processing engine 120 from the query suggestion engine 110 via communications network 101. The query suggestions may be transmitted in response to a user on computing device 130 entering the partial query “brit.”

At step 205, one or more of the query suggestion results are identified for annotating with a description. In some implementations the query processing engine 120 may identify whether it is desirable to annotate a query suggestion with a description. In some implementations search result documents and/or search results responsive to a query suggestion may be analyzed to identify whether it is desirable to annotate that query suggestion with a description. In some implementations determination of whether to annotate a given query suggestion may be based at least in part on whether that query suggestion refers to an entity. For example, analysis of search results for “britney spears”, “brittany murphy”, “british airways”, and “britax” may identify each of the query suggestions as entities. For example, search results for “britney spears” may include her personal website, her Twitter Account, a Wikipedia page directed toward her, and news stories directed toward her as illustrated in the displayed results in FIG. 5. Each of these results may indicate that “britney spears” is an entity.

The term “entity” refers to any object that can have associated properties (e.g., an object in the physical, conceptual, or mythical world). In some implementations entities are topics of discourse. In some implementations, entities are persons, places, concepts, and/or things that can be referred to by a text fragment (e.g., a term or phrase) and are distinguishable from one another (e.g., based on context). For example, the text “bush” on a webpage may potentially refer to multiple entities such as President George Herbert Walker Bush, President George Walker Bush, a shrub, and the rock band Bush. When the meaning is clear from context, and to avoid unnecessary verbiage, the term “entity” may also be used herein to refer to the text that references the entity.

In some implementations if a query suggestion references an entity, then it will automatically be identified for annotating with a description. In some implementations additional and/or alternative factors may be taken into account in determining whether to annotate with a description. In some implementations popularity of a referenced entity may be taken into account in determining whether to annotate that entity with a description. For example, in some implementations “michael jordan” may not be annotated with a description such as “basketball player” since it may be determined that Michael Jordan is highly popular and readily recognizable as a basketball player. In some implementations popularity may be determined utilizing, for example, analysis of search results returned when searching for an entity. For example, if references to an entity dominate search results then that entity may be identified as popular and/or if it is clear from search query records that users recognize the entity then that entity may be identified as popular.

In some implementations an informational repository may additionally and/or alternatively be analyzed to identify whether a query suggestion references an entity. For example, in some implementations a private and/or a public knowledge database and/or knowledge graph may be analyzed to determine whether a query suggestion is associated with one or more entities. For example, in some implementations Wikipedia, Freebase, and/or the CIA's World Facts book may be utilized. In some implementations if the informational repository identifies that query suggestion as referencing an entity, then it may be determined it is potentially desirable to annotate that query suggestion. For example, analysis of a database for “britney spears” may identify that she is a musician, a female, and a celebrity—all of which may be indicative of her status as an entity. Also, for example, in some implementations a database having a mapping of queries to entities associated with those queries may be analyzed. Such database may contain, for each of one or more queries, identification of one or more entities associated with the query.

Also, for example, in some implementations matching names of known entities to the query suggestion may additionally and/or alternatively be utilized to determine if a query suggestion references an entity. For example, for a query suggestion of “Britney Spears”, “Britney Spears” may be matched to a known name (Britney Spears) for the entity associated with Britney Jean Spears the artist. Also, for example, in some implementations matching additional and/or alternative properties of known entities to the query suggestion may additionally and/or alternatively be utilized to determine if a query suggestion references an entity. For example, for a query suggestion of “Britney Spears artist”, “Britney Spears” may be matched to a known name (Britney Spears) for the entity associated with Britney Jean Spears the artist and “artist” may be matched to an entity type (artist) associated with the entity associated with Britney Jean Spears the artist. In some implementations an exact match between the query suggestion and one or more property of the entity may not be required. For example, in some implementations stemming of one or more terms, synonyms of one or more terms, spell correction of one or more terms, etc. may be utilized.

In some implementations determination of whether to annotate a given query suggestion may additionally and/or alternatively be based at least in part on whether that query suggestion is sufficiently ambiguous. In some implementations whether a query suggestion is sufficiently ambiguous may be based on whether search results for that query suggestion are ambiguous. For example, analysis of a group of search results for a query suggestion of “Roosevelt” may identify high quality and/or a high quantity of results for at least three distinct entities: Roosevelt University; Franklin D. Roosevelt; and Theodore Roosevelt. Since results for all three of these entities may be returned in a group of search results for “Roosevelt,” it may be determined that “Roosevelt” is an ambiguous query suggestion. In some implementations if a query suggestion is identified as ambiguous, then it will automatically be identified for annotating with a description. In some implementations additional and/or alternative factors may be taken into account in determining whether to annotate with a description. For example, in some implementations how ambiguous an entity is may be taken into account in determining whether to annotate that query suggestion with a description. For example, in some implementations search results for a given query suggestion may return multiple entities, but they may be overwhelmingly dominated by a single entity and the given query suggestion thus identified as not being sufficiently ambiguous. Also, for example, in some implementations search results for a given query suggestion may only include references to secondary entities that are determined to be of insignificant quality and/or quantity and the given query suggestion identified as not being sufficiently ambiguous.

In some implementations a private and/or a public knowledge database and/or knowledge graph may additionally and/or alternatively be analyzed to determine whether a query suggestion is sufficiently ambiguous. For example, in some implementations Wikipedia, Freebase, and/or the CIA's World Facts book may be utilized. For example, if a search in Wikipedia for one or more terms in a query suggestion leads to a disambiguation page, then such query suggestion may be identified as likely to be ambiguous. Also, for example, if one or more terms in a query suggestion are associated with multiple popular entities identified in a database, then the query suggestion may be identified as likely to be ambiguous. For example, the term “phoenix” may be associated with the entity for the city in Arizona and the entity for the rock band from France. The entities associated with the city in Arizona and/or the rock band from France may be identified via one or more database. For example, the alias “phoenix” may be mapped to both entities in a database. In some implementations the database may optionally provide an indication of the popularity of the entities. In some implementations popularity may otherwise be determined. In some implementations if the one or more database identifies that query suggestion as sufficiently ambiguous, then it may be determined it is potentially desirable to annotate that query suggestion.

In some implementations whether a query suggestion should be annotated with a description may be based on consultation of a database of query suggestions and whether they should be annotated. For example, a query suggestion database (e.g., stored in content database 115) may include a listing of known query suggestions and whether each should be annotated. Such a database may be consulted as the sole determination or as a part of a determination of whether a query suggestion should be annotated. Additional and/or alternative methods for determining whether a query suggestion should be annotated with a description may be utilized. For example, additional and/or alternative methods may be utilized to determine whether a query suggestion references an entity, such as one or more of statistical analysis, part-of-speech tagging, a dependency parser, and/or whether a term is capitalized (which may indicate its usage as a proper noun).

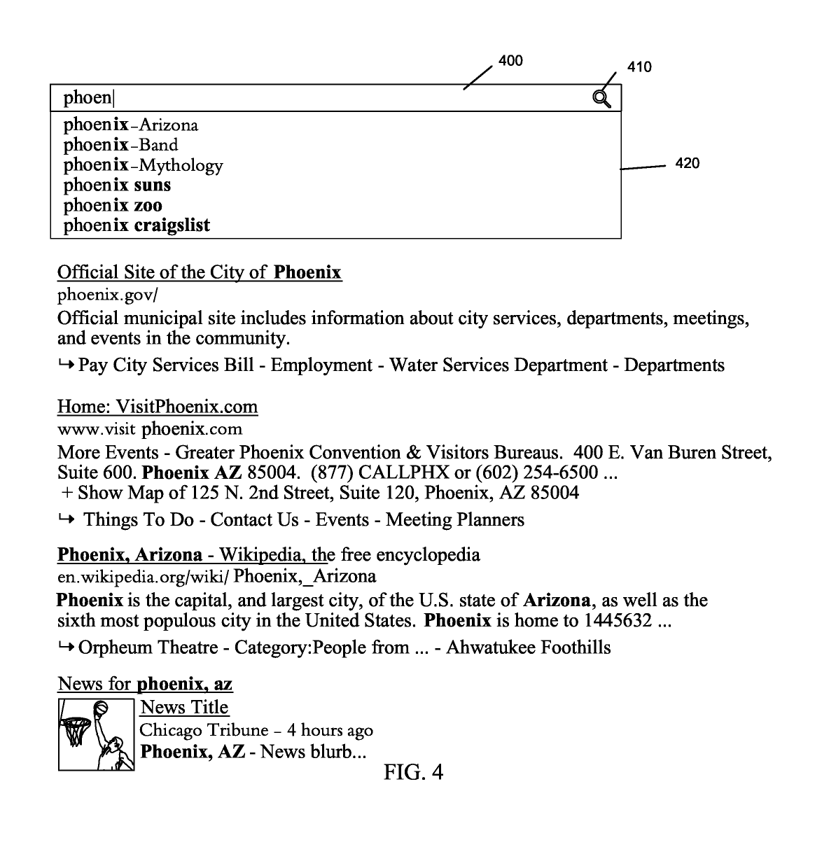

At step 210, a description for each of the identified query suggestions is identified. In some implementations each of the query suggestions identified for annotating may be provided to query suggestion annotation engine 125 by query processing engine 120 and query suggestion annotation engine 125 may identify a description for each of the identified query suggestions. In some implementations if a query suggestion result is unambiguous, then only a single description may be provided for the query suggestion. For example, with reference to FIG. 5, “britney spears”, “brittany murphy”, “british airways”, and “britax” are each identified as unambiguous query suggestions and are each only identified with a single description—respective of “singer”, “actress”, “airline”, and “car seats and strollers”. In some implementations if a query suggestion is ambiguous, then a plurality of suggestions may be provided for the query suggestion to help reflect various possible meanings of the query suggestion. For example, with reference to FIG. 4, “phoenix” is identified as an ambiguous query suggestion and identified with three separate descriptions—“arizona”, “band”, and “mythology”. Also, for example, a query suggestion result “Roosevelt” may be identified as an ambiguous query suggestion and identified with two separate descriptions—“FDR” and “teddy”.

In some implementations, when an entity is unambiguous, a description for an entity may be determined based at least in part on reference to a private and/or a public knowledge database and/or knowledge graph. For example, in some implementations a knowledge graph may be consulted to determine an initial list of potential descriptions for annotating a query suggestion. For example, a knowledge graph identifier for the entity associated with the President “Bill Clinton” may include a number of descriptions associated with “Bill Clinton” including “president”, “governor”, “author”, “42^{nd} president”, and “politician” and all such descriptions or a subset of all such descriptions may be selected as an initial list of potential descriptions. In some implementations an actual description may be selected from the initial list of potential descriptions based at least in part on the popularity of the each of the potential descriptions in another source. For example, the Wikipedia entry for Bill Clinton may be consulted to determine one or more aspects of a document centric weighting for each of the potential descriptions. For example, for each of the potential descriptions, one or more of the following may be analyzed in determining a document centric weighting: in which field(s) the potential description occurs, how often the potential description occurs in those fields, how early the potential description occurs in those fields, and/or decorations applied to the potential descriptions. For example, the actual description may be determined by analyzing the Wikipedia entry for Bill Clinton and determining which of the potential descriptions occurs first in the Wikipedia entry. Additional and/or alternative weightings may additionally and/or alternatively be utilized such as term frequency inverse document frequency (TFIDF) weighting.

In some implementations, a description for a query suggestion may be determined based at least in part on a type of entity with which it is associated. For example, in some implementations if a query suggestion is associated with a certain type of entity, the description of that type may conform to a certain template associated with that type. For example, if a query suggestion is associated with an entity identified as a president—its description may conform to the description template “US President #”, where “#” is the president number. Also, for example, if a query selection references an entity identified as a movie, its description may conform to the description template—“Movie [year]”, where “year” is the release year of the movie. Also, for example, if a query suggestion is associated with an entity identified as a song, its description may conform to the description template—“[Artist] [year]”, where “Artist” is the musician and “year” is the release year of the song. Identification of a query selection as associated with a specific type of entity and/or identification of certain parameters to be included in a template may be determined based at least in part on reference to a private and/or a public knowledge database and/or knowledge graph that includes such information.

In some implementations, which description should be provided with a query suggestions may be based on consultation of a database of query suggestions and accompanying descriptions. For example, a query suggestion database (e.g., stored in content database 115) may include a listing of known query suggestions and include at least one preferred description for each of the query suggestions. Such a database may be consulted to identify an initial list of potential descriptions and/or the actual description to be utilized.

In some implementations, when a query suggestion is ambiguous, descriptions for the query suggestion may be determined based at least in part on analysis of search results for the query suggestion. For example, with reference to FIG. 4, “phoenix” is an ambiguous query suggestion and identified with three separate descriptions: “arizona”, “band”, and “mythology”. In some implementations those descriptions may be determined based at least in part on analysis of search results and/or associated search result documents for the query suggestion. For example, analysis of a group of search results for the term “phoenix” may have identified that the search results were primarily focused on the city in Arizona, but also focused to a significant degree on the mythological creature, and on the band. Accordingly, three separate descriptions may be provided each focusing on a separate aspect of the term phoenix—focusing on the city, the mythological creature, and the band. In some implementations the group of search results analyzed may include a subset of the search results such as the top 20 search results, the search results displayed initially in response to a search query, etc.

In some implementations, the particular description utilized for each aspect of the term phoenix may be determined as described herein. For example, in some implementations the description for the city in Arizona may be determined based on consultation of a knowledge graph to determine an initial list of potential descriptions for annotating that aspect of the query suggestion. The actual description may then be selected from the initial list of potential descriptions by analyzing the popularity of each of the potential descriptions in another source and/or the knowledge graph itself. Also, for example, in some implementations the description for the city in Arizona may be based on consultation of a database of query suggestions and accompanying descriptions.

Also, for example, in some implementations, when a query suggestion is ambiguous, descriptions for the query suggestion may be determined based at least in part on analysis of other sources. For example, if a search in Wikipedia for one or more terms of a query suggestion leads to a disambiguation page, then the different descriptions provided for such query suggestion may be based at least in part on information on that disambiguation page. For example, in some implementations descriptions related to the top results on the disambiguation page may be utilized. Also, for example, in some implementations both the results on the disambiguation page for one or more terms of a query suggestion and the search results responsive to those terms may be utilized. For example, five descriptions may be identified via a disambiguation page for a given query suggestion and those five may be narrowed down to three based on frequency of occurrence of each in search result documents responsive to the query suggestion. Also, for example, in some implementations, when a query suggestion is ambiguous, descriptions for the query suggestion may be determined based at least in part on consultation of a database of query suggestions and accompanying descriptions. Additional and/or alternative methods for determining an actual description for a query selection may be utilized. For example, in some implementations the length of the description may be taken into account. For example, a shorter description may be preferred over a longer description to promote ease of reading and/or to enable viewing of the entire description on the allotted screen space.

At step 215, each description is presented in combination with respective of the query suggestion results. In some implementations each of the identified query suggestions and accompanying descriptions may be provided to computing device 130 by query suggestion engine 120 and/or query suggestion annotation engine 125 for display by computing device 130. For example, in some embodiments the query suggestions and accompanying descriptions may be displayed on browser 132 after being received from query suggestion engine 120 and/or query suggestion annotation engine 125. For example, with reference to FIG. 5, each of “britney spears”, “brittany murphy”, “british airways”, and “britax” are each displayed with respective descriptions “singer”, “actress”, “airline”, and “car seats and strollers”. The descriptions are presented in a lighter font following the query suggestions and separated from the query suggestions by an “em” dash. Search results pertaining to the top listed query suggestion “britney spears” are provided below the query suggestions.

Also, for example, with reference to FIG. 4, “phoenix” is displayed three separate times, each time with a different of three separate descriptions—“arizona”, “band” and “mythology”. The descriptions are presented in a lighter font following the query suggestions and separated from the query suggestions by an “em” dash. No descriptions are included with the query suggestions “phoenix suns”, “phoenix zoo”, and “phoenix craigslist.” Those query suggestions were not identified for annotating with a description (e.g., they may have been identified as sufficiently descriptive standing alone). Search results pertaining to the top listed query suggestion “phoenix” as it pertains to its top listed description as a city in Arizona are provided below the query suggestions. As discussed herein, in some implementations a search based on the query suggestion “phoenix” as it pertains to its top listed description as a city in Arizona may be based on the query suggestion and the description as displayed (e.g., “phoenix—arizona”) or may be based on the query suggestion and the description (e.g., “phoenix city arizona”)

In some implementations the displayed query suggestions may optionally be ranked. For example, those query suggestions having results with the highest signal ranking and/or the highest frequency of query may be ranked the highest and be presented first to a user as a query suggestion (e.g., presented at the top of a query suggestion list). For example, with reference to FIG. 5, “britney spears” may have a higher frequency of query than “brittany murphy” and accordingly be displayed first. Also, in implementations that include a plurality of descriptions for an ambiguous query suggestion, those descriptions may optionally be ranked. For example, those descriptions having related search results, as determined by searching for the query suggestion without the description, with the highest signal ranking may be ranked the highest and be presented first to a user as a query suggestion. Also, for example, those descriptions having related search results, as determined by searching for the query suggestion with the description and/or based on the description, with the highest signal ranking and/or the highest frequency of query may be ranked the highest and be presented first to a user as a query suggestion.

Although specific displays of descriptions associated with query suggestions are illustrated in FIGS. 4 and 5, additional and/or alternative displays may be provided. For example, in some implementations a query suggestion and its description may be displayed in different columns in a table. Also, for example, in some implementations a query suggestion and its description may be presented on different lines (e.g., with the query suggestion above the description). Also, for example, in some implementations a description for a query suggestion may be presented when the query suggestion is hovered over via a user interface device.

The user may optionally choose any of the query suggestions displayed to the user and utilize such query suggestion as a completed query or the basis for a completed query to retrieve information based on the identified query suggestion and, optionally, additionally on any identified accompanying description. For example, in some implementations, when an ambiguous query suggestion is presented in combination with multiple descriptions (e.g., “phoenix” presented with “arizona”, “band”, and “mythology” in FIG. 4), the particular presentation selected will determine the query that is submitted to an information retrieval system such as search engine 105. For example, in some implementations selection of query suggestion “phoenix” with description “arizona” will cause a query to be submitted for “phoenix city.” Also, for example, in some implementations selection of query suggestion “phoenix” with description “arizona” will cause a query to be submitted that retrieves only documents associated with an identifier that references such documents as pertaining particularly to the city Phoenix in Arizona. Also, for example, in some implementations selection of query suggestion “phoenix” with description “arizona” will cause a query to be submitted for “phoenix”, whose search results are filtered to omit any documents that are not mainly associated with the city Phoenix in Arizona.

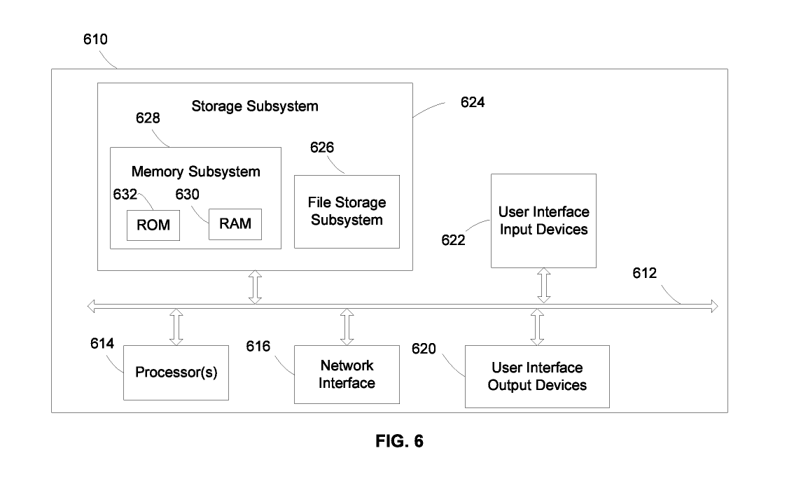

Also, for example, in some implementations, when an unambiguous query suggestion is presented in combination with multiple descriptions (e.g., “singer” presented with “britney spears” in FIG. 6), the particular presentation selected will determine the query that is submitted to an information retrieval system such as search engine 105. For example, in some implementations selection of query suggestion “britney spears” with description “singer” will cause a query to be submitted for “britney spears” only. Also, for example, in some implementations selection of query suggestion “britney spears” with description “singer” will cause a query to be submitted for “britney jean spears.” Also, for example, in some implementations selection of query suggestion “britney spears” with description “singer” will cause a query to be submitted that retrieves only documents associated with an identifier that references such documents as pertaining particularly to the singer Britney Spears. Also, for example, in some implementations selection of query suggestion “britney spears” with description “singer” will cause a query to be submitted for “britney spears”, whose search results are filtered to omit any documents that are not mainly associated with the singer.

Although methods of generating query suggestion result annotations for a partial query are illustrated in the FIGS., the methods may additionally and/or alternatively be utilized to generate a query suggestion result and accompanying description for a completed search query. For example, query suggestions may be displayed with search results in response to a completed submitted search query. Certain implementations of the methods of generating query suggestion result annotations have been described as taking place in a substantially real time environment. For example, certain implementations have discussed identifying query suggestion results for annotating with a description, generating and/or identifying a description for each of the identified query suggestion results, presenting each description in combination with respective of the query suggestion results, and/or facilitating information retrieval based on the query suggestion results and the description. However, in some implementations one or more aspects of methods described herein may be implemented in an offline mode. For example, implementations of methods described herein may be utilized to generate a database of query suggestions and accompanying descriptions that may be made available for utilization in a real time environment in suggesting future accompanying descriptions for query suggestions.

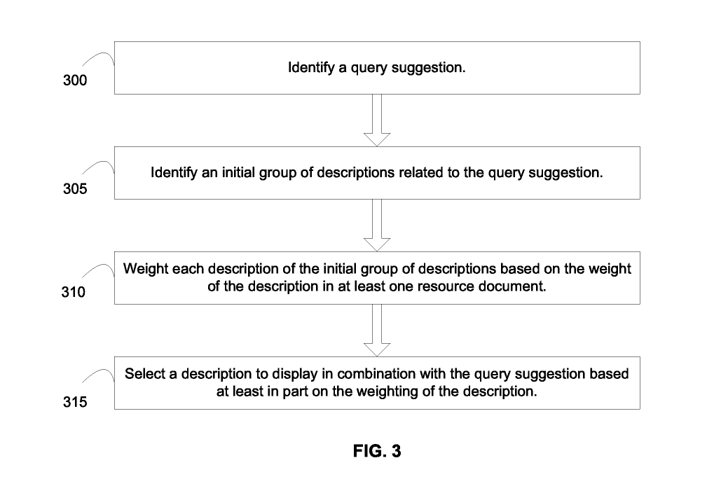

Referring to FIG. 3, a flow chart illustrating steps of an example method of selecting a description to display in combination with a query suggestion is illustrated. Other implementations may perform the steps in a different order, omit certain steps, and/or perform different and/or additional steps than those illustrated in FIG. 3. For convenience, aspects of FIG. 3 will be described with reference to a system of one or more computers that perform the process. The system may include, for example, the query suggestion annotation engine 125 of FIG. 1. In some implementations the steps of FIG. 3 may share one or more common aspects with step 210 of FIG. 2.

At step 300 a query suggestion is identified. For example, in some implementations the query suggestion may be provided to the query processing engine 120 from the query suggestion engine 110 via communications network 101. In some implementations the query suggestion may optionally be provided in response to a user entering a partial query on computing device 130. In some implementations the query suggestion may optionally be provided in response to a user entering a full query on computing device 130. In some implementations the query suggestion may optionally be provided in response to determining descriptions to display in combination with stored query suggestions in a database.

At step 305 an initial group of descriptions is identified that is related to the identified query suggestion. For example, in some implementations a knowledge graph may be consulted to determine an initial list of potential descriptions for annotating a query suggestion. Also, for example, in some implementations a first resource document (e.g., a primary search result, a database) related to the identified query suggestion is consulted to determine an initial list of potential descriptions for annotating a query suggestion. One or more canonicalization rules may optionally be applied to the initial group of descriptions. For example, resource documents may identify Phoenix as the “city in Arizona” and that description canonicalized to “city Arizona”.

At step 310 each description of the initial group of descriptions is weighted based on the weight of the description in at least one resource document. For example, for each of the potential descriptions, one or more of the following may be analyzed: in which field(s) the potential description occurs, how often the potential description occurs in those fields, how early the potential description occurs in those fields, and/or decorations applied to the potential descriptions. The resource document in step 310 may be distinct from any resource document optionally utilized in step 305. One or more canonicalization rules may optionally be applied to words in the resource document to modify and/or omit certain words.

At step 315 a description is selected to display in combination with the query suggestion based at least in part on the weighting of the description. For example, in some implementations the highest weighted description is selected. Also, for example, in some implementations the highest weighted description that is less than a certain number of words and/or a certain number of characters is selected. Also, for example, in some implementations the selected description is based in part on the weighting of the description in the resource document and in part on existence and/or weighting of the description in search results for the query suggestion.

FIG. 4 is a partial screenshot that illustrates an example environment that can be used to provide query suggestion results to a user. In FIG. 4, the partial screen shot includes a search field representation 400 and a search button representation 410. In this example, the user has entered the partial query “phoen” into the search field representation and a drop down menu 420 of the search field is displayed. The drop down menu 420 includes the query suggestions as discussed herein, some of which are annotated with descriptions. The user may optionally choose any of the query suggestions and utilize such suggestion as a completed query or the basis for a completed query to retrieve information based on the identified query suggestion and, optionally, additionally on any identified accompanying description.

FIG. 5 is a partial screenshot that illustrates an example environment that can be used to provide query suggestion results to a user. In FIG. 5, the partial screen shot includes a search field representation 500 and a search button representation 510. In this example, the user has entered the partial query “brit” into the search field representation and a drop down menu 520 of the search field is displayed. The drop down menu 520 includes the query suggestions as discussed herein, all of which are annotated with descriptions. The user may optionally choose any of the query suggestions and utilize such suggestion as a completed query or the basis for a completed query to retrieve information based on the identified query suggestion and, optionally, additionally based on any identified accompanying description.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 628 and a file storage subsystem 626, user interface input devices 622, user interface output devices 620, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to annotate query suggestions according to one or more processes described herein.

These software modules are generally executed by processor 614 alone or in combination with other processors. Memory 628 used in the storage subsystem can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several inventive implementations have been described and illustrated herein, a variety of other means and/or structures for performing the function and/or obtaining the results and/or one or more of the advantages described herein, and each of such variations and/or modifications is deemed to be within the scope of the inventive implementations described herein. More generally, all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over vocabulary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1-25. (canceled)

26. A computer implemented method for annotating query suggestions for a query, comprising:
identifying query suggestions for a query;
determining that a selected query suggestion of the query suggestions is associated with a particular entity;
identifying an entity type of the particular entity;
identifying a template for the entity type of the entity, the template defining at least one fixed term, at least one variable field, and a positional relationship for the fixed term and the variable field, the variable field associated with a property for the entity type;
determining a variable field term for the variable field of the entity template based on identifying the variable field term as a value for the property for the particular entity;
generating a description for the selected query suggestion based on the template, the description including the fixed term and the variable field term in the positional relationship;
appending the description to the selected query suggestion for providing to a user as an annotated query suggestion that includes the selected query suggestion, and includes the fixed term and the variable field term in the positional relationship;
receiving the query;
identifying the annotated query suggestion as responsive to the query; and
providing, in response to the query, the annotated query suggestion for selection of the annotated query suggestion to issue a search based on the annotated query suggestion.

27. The method of claim 26, further comprising:
receiving a single selection by the user of the annotated query suggestion with the appended description; and
submitting a submission query in response to the single selection, wherein the submission query is directed to the particular entity and includes at least one term that is not included in the query suggestion and not included in the appended description.

28. The method of claim 26, further comprising:
determining that the selected query suggestion is associated with an additional entity;
identifying, based on the additional entity, an additional description for the selected query suggestion; and
appending the additional description to the selected query suggestion for providing to the user as an additional annotated query suggestion in response to entry of the query by the user.

29. The method of claim 28, further comprising:
receiving a single selection by the user of the additional annotated query suggestion with the appended additional description; and
submitting a submission query in response to the single selection, wherein the submission query is directed to the additional entity and includes at least one term that is not included in the query suggestion and not included in the additional appended description.

30. The method of claim 28, wherein identifying the additional description for the selected query suggestion comprises:
identifying an additional entity type of the additional entity, the additional entity type different from the entity type;
identifying an additional template for the additional entity type of the additional entity, the additional template defining at least one additional fixed term and at least one additional variable field, the additional fixed term different from the fixed term and the additional variable field different from the variable field and associated with an additional property for the additional entity type;
determining an additional variable field term for the additional variable field of the additional entity template based on identifying the additional variable field term as an additional value for the additional property for the additional entity; and
generating the additional description for the selected query suggestion based on the additional template, the additional description including the additional fixed term and the additional variable field term.

31. The method of claim 26, further comprising:
determining that the selected query suggestion is ambiguous;
wherein generating the description for the selected query suggestion based on the template is in response to determining that the selected query suggestion is ambiguous.

32. The method of claim 31, wherein determining that the selected query suggestion is ambiguous includes:
issuing a search based on the selected query suggestion;
identifying search results based on the search;
identifying ambiguity of the search results, wherein ambiguity of the search results is based on entities identified in the search results; and
determining the selected query suggestion is ambiguous based on the ambiguity of the search results.

33. The method of claim 31, wherein determining that the selected query suggestion is ambiguous includes analyzing a group of provided search results based on the selected query suggestion.

34. The method of claim 26, wherein determining that the selected query suggestion is associated with the particular entity is based on comparing one or more terms of the selected query suggestion to an entity property of the particular entity.

35. A system, comprising:
memory; and
one or more processors operable to execute instructions stored in the memory, the instructions comprising instructions to:
identify query suggestions for a query;
determine that a selected query suggestion of the query suggestions is associated with a particular entity;
identify an entity type of the particular entity;
identify a template for the entity type of the entity, the template defining at least one fixed term, at least one variable field, and a positional relationship for the fixed term and the variable field, the variable field associated with a property for the entity type;
determine a variable field term for the variable field of the entity template based on identifying the variable field term as a value for the property for the particular entity;
generate a description for the selected query suggestion based on the template, the description including the fixed term and the variable field term in the positional relationship;
append the description to the selected query suggestion for providing to a user as an annotated query suggestion that includes the selected query suggestion, and includes the fixed term and the variable field term in the positional relationship;
receive the query;
identify the annotated query suggestion as responsive to the query; and
provide, in response to the query, the annotated query suggestion for selection of the annotated query suggestion to issue a search based on the annotated query suggestion.

36. The system of claim 35, wherein the instructions further comprise instructions to:
receive a single selection by the user of the annotated query suggestion with the appended description; and
submit a submission query in response to the single selection, wherein the submission query is directed to the particular entity and includes at least one term that is not included in the query suggestion and not included in the appended description.

37. The system of claim 35, wherein the instructions further comprise instructions to:
determine that the selected query suggestion is associated with an additional entity;
identify, based on the additional entity, an additional description for the selected query suggestion; and
append the additional description to the selected query suggestion for providing to the user as an additional annotated query suggestion in response to entry of the query by the user.

38. The system of claim 37, wherein the instructions further comprise instructions to:
receive a single selection by the user of the additional annotated query suggestion with the appended additional description; and
submit a submission query in response to the single selection, wherein the submission query is directed to the additional entity and includes at least one term that is not included in the query suggestion and not included in the additional appended description.

39. The system of claim 37, wherein the instructions to identify the additional description for the selected query suggestion comprise instructions to:
identify an additional entity type of the additional entity, the additional entity type different from the entity type;
identify an additional template for the additional entity type of the additional entity, the additional template defining at least one additional fixed term and at least one additional variable field, the additional fixed term different from the fixed term and the additional variable field different from the variable field and associated with an additional property for the additional entity type;
determine an additional variable field term for the additional variable field of the additional entity template based on identifying the additional variable field term as an additional value for the additional property for the additional entity; and
generate the additional description for the selected query suggestion based on the additional template, the additional description including the additional fixed term and the additional variable field term.

40. The system of claim 35, wherein the instructions further comprise instructions to:
determine that the selected query suggestion is ambiguous;
wherein generating the description for the selected query suggestion based on the template is in response to determining that the selected query suggestion is ambiguous.

41. The system of claim 40, wherein the instructions to determine that the selected query suggestion is ambiguous comprise instructions to:
issue a search based on the selected query suggestion;
identify search results based on the search;
identify ambiguity of the search results, wherein ambiguity of the search results is based on entities identified in the search results; and
determine the selected query suggestion is ambiguous based on the ambiguity of the search results.

42. The system of claim 40, wherein the instructions to determine that the selected query suggestion is ambiguous comprise instructions to analyze a group of provided search results based on the selected query suggestion.

43. The system of claim 35, wherein the instructions to determine that the selected query suggestion is associated with the particular entity include instructions to determine the selected query suggestion is associated with the particular entity based on comparing one or more terms of the selected query suggestion to an entity property of the particular entity.

44. A non-transitory computer readable storage medium storing computer instructions executable by a processor to perform a method comprising:
identifying query suggestions for a query;
determining that a selected query suggestion of the query suggestions is associated with a particular entity;
identifying an entity type of the particular entity;
identifying a template for the entity type of the entity, the template defining at least one fixed term, at least one variable field, and a positional relationship for the fixed term and the variable field, the variable field associated with a property for the entity type;
determining a variable field term for the variable field of the entity template based on identifying the variable field term as a value for the property for the particular entity;
generating a description for the selected query suggestion based on the template, the description including the fixed term and the variable field term in the positional relationship;
appending the description to the selected query suggestion for providing to a user as an annotated query suggestion that includes the selected query suggestion, and includes the fixed term and the variable field term in the positional relationship;
receiving the query;
identifying the annotated query suggestion as responsive to the query; and
providing, in response to the query, the annotated query suggestion for selection of the annotated query suggestion to issue a search based on the annotated query suggestion.

45. The method of claim 26, further comprising:
receiving a single selection by the user of the annotated query suggestion with the appended description; and
submitting a submission query in response to the single selection, wherein the submission query is directed to the particular entity and differs from the annotated query suggestion with the appended description.
